(19) United States
(12) Patent Application Publication
(10) Pub. No.: US 2024/0278353 A1
(43) Pub. Date: Aug. 22, 2024

(54) DEVICE FOR PRODUCING BIPOLAR PLATES

(71) Applicant: Weil Technology GmbH, Müllheim (DE)

(72) Inventors: Florian WEIL, Müllheim (DE); Harald LIEBHART, Müllheim (DE)

(73) Assignee: Weil Technology GmbH, Müllheim (DE)

(21) Appl. No.: 18/568,896

(22) PCT Filed: Apr. 21, 2022
(86) PCT No.: PCT/EP2022/060493

§ 371 Date: Dec. 11, 2023

(30) Foreign Application Priority Data
Jun. 15, 2021 (DE) 10 2021 115 494.4

(51) Int. Cl. B23K 26/21; B23K 26/03; B23K 26/06; B23K 26/082; B23K 26/12; B23K 37/04; B23K 37/047; B23K 101/38; H01M 4/86; H01M 4/88

(52) U.S. Cl. CPC B23K 26/21; B23K 26/032; B23K 26/0604; B23K 26/082; B23K 26/123; B23K 37/0408; B23K 37/0435; B23K 37/047; B23K 2101/38; H01M 2004/8694; H01M 4/88

(57) ABSTRACT

In order to improve the production of bipolar plates (2), as are used, for example, for fuel cells, a device (1) is provided, which has two fixed laser scanners (5) at a processing station (3, 4), which are configured for the preferably fluid-tight welding of individual plates (6) of a bipolar plate (2) to be produced.

### CROSS-REFERENCE TO RELATED APPLICATIONS

This Application is a 371 National Phase of PCT/EP2022/060493, filed Apr. 21, 2022, which claims priority to German Patent Application No. 10 2021 115 494.4, filed Jun. 15, 2021, both of which are incorporated herein by reference as if fully set forth.

### TECHNICAL FIELD

The invention relates to a device for producing bipolar plates, as are used in fuel cells, for example.

### BACKGROUND

Bipolar plates generally consist of two individual plates which are connected to one another and form fluid-guiding structures between them, such as channels.

The individual plates from which bipolar plates are produced consist, for example, of sheet metal blanks, in particular of stainless steel or also of titanium. Bipolar plates are essential components of fuel cell systems and are layered to form so-called stacks. The bipolar plates arranged in stacks form the core of a fuel cell system here. The bipolar plates, as integrated assemblies, fulfill the tasks of electrically connecting individual cells, distributing gas over the surface of the bipolar plates, partitioning gas between adjoining cells, sealing to the outside, and cooling, among other things.

The quality of the bipolar plates, from which a fuel cell system is formed, is essential here for the quality of the fuel cell system.

The quality of the bipolar plates is also influenced by the accuracy of the connection of the two individual plates, from which the bipolar plates are each manufactured. The smallest possible manufacturing tolerances are desirable in this case.

### SUMMARY

The object of the invention is therefore a device for producing bipolar plates which promotes the most accurate possible manufacturing of bipolar plates.

To achieve the object, a device for producing bipolar plates of the type mentioned at the outset is proposed, which has one or more of the means and features disclosed herein directed to such a device. To achieve the object, therefore in particular a device for producing bipolar plates is proposed, which comprises at least one processing station having at least two stationary laser scanners, which are configured to create a preferably fluid-tight, in particular gas-tight, welded bond between two individual plates forming a bipolar plate.

Due to the stationary, i.e., fixed arrangement of two laser scanners in a processing station, processing tolerances can be kept small when creating the welded bond between the two individual plates forming a bipolar plate. Furthermore, it is possible to half the cycle time during welding due to the use of two laser scanners when welding the individual plates of a bipolar plate. The manufacturing of the bipolar plates can be accelerated in this way.

The use of two laser scanners in a processing station moreover promotes a symmetrical introduction of heat into the individual plates during welding, which can reduce or even completely avoid warping of the bipolar plate to be produced during the creation of the welded bond between its two individual plates. This also promotes the most precise possible manufacturing of bipolar plates with comparatively small manufacturing tolerances.

In this context, it can be advantageous if the device is configured, for example, by at least one control unit configured for this purpose, to activate the two laser scanners of the at least one processing station so that the welded bond is created symmetrically and/or a symmetrical introduction of heat into the individual plates takes place during the creation of the welded bond between the two individual plates. The at least one control unit can be integrated into one of the laser scanners and/or connected to the laser scanners.

In one preferred embodiment of the device, it is provided that it has at least two processing stations which each comprise two stationary laser scanners which are configured to create a preferably fluid-tight, in particular gas-tight, welded bond between two individual plates forming a bipolar plate.

A first part of the welded bond can be created between the two individual plates of a bipolar plate in a first of the two processing stations, while the remaining part of the welded bond is created between the two individual plates in the second processing station. The creation of the preferably fluid-tight, in particular gas-tight welded bond between the individual plates of the bipolar plate is therefore distributed onto two processing stations.

The use of two processing stations furthermore allows the comparatively filigree individual plates of the bipolar plates to be produced to be clamped over the largest area possible in the first processing station and the first part of the welded bond to be created using the two laser scanners of the first processing station. The large-area clamping of the individual plates can prevent warping of the individual plates during welding and inaccuracies connected thereto. Another clamping, which is also over the largest area possible, of the individual plates can take place in the second processing station, which permits the finishing of the welded bond between the individual plates using the two laser scanners of the second processing station.

The two laser scanners of a processing station can jointly form a double-field laser scanner. The laser scanners can be arranged and/or activated and/or configured here such that their scanning fields mutually overlap. It is to be noted in this context that the device can have a control unit for activating all laser scanners. Among other things, however, it is also possible that each processing station is assigned in each case at least one control unit.

If the two laser scanners of a processing station have scanning fields which overlap and/or are as large as possible, it is possible to produce bipolar plates of different sizes without changing the position of the laser scanners during the welding of the individual plates. The laser scanners can therefore remain stationary even with large bipolar plates. This promotes high manufacturing accuracy. Overlapping scanning fields can additionally be advantageous for the already above-mentioned symmetrical introduction of heat during the welding of the individual plates.

The at least one processing station of the device can have at least one optical sensor, for example, a camera and/or a vision sensor. With the aid of the at least one optical sensor, it is possible to check a position of a welded bond created using the two laser scanners, to activate the two laser scanners to produce the welded bond accordingly, and/or to perform matching of the scanning fields of the two laser scanners. Furthermore, the optical sensor can be used for offsetting, thus zero point setting, of the scanning fields in dependence on the individual plates to be respectively processed and their clamping on the processing station.

The at least one optical sensor can be integrated in this case in one of the two laser scanners of the at least one processing station. In one embodiment of the device, each laser scanner has in each case such a, preferably integrated, optical sensor.

The device can have a conveying device, for example, a rotary indexing table, via which at least one processing station, in particular the already above-mentioned processing stations, and/or a charging station and/or a removal station of the device are connected to one another for conveying. The device can be made particularly compact if a rotary indexing table is used as the conveying device. The individual stations of the device can then be arranged around it on a comparatively small footprint. In this way, the device may be integrated particularly easily into an existing production layout. The use of a rotary indexing table can additionally reduce to a minimum a number of clamping means used for clamping the individual plates, which are also designated as floor tools and will be explained in more detail hereinafter.

The device can have in each case a floor tool for each station of the device, in particular for each processing station and/or for a, for example the already above-mentioned, charging station, and/or for a, for example the already above-mentioned, removal station. The floor tool can be used as the transport means and clamping means for individual plates of bipolar plates to be produced, but also for finished bipolar plates. If the floor tools are to be used as transport means, it is advantageous if they are movable along the conveying device from station to station of the device. The floor tools can be part of the conveying device for this purpose.

In one embodiment of the device, the at least one floor tool can comprise a workpiece holder, which can be moved from its starting position into a processing position, in particular can be raised in the vertical direction, for at least one individual plate and/or a finished bipolar plate.

With the aid of the workpiece holder of the at least one floor tool, individual plates of a bipolar plate to be produced can be presented and/or clamped properly on the at least one processing station of the device for welding.

For clamping the individual plates during welding, each processing station of the device can have a clamping device for individual plates of a bipolar plate to be produced, which comprises a head tool that is stationary, thus fixed in position, relative to the laser scanners of the processing station.

A movable floor tool of the device can be assigned at least temporarily to the head tool. It can be advantageous if the head tool is configured for centering the floor tool and in particular its preferably movable workpiece holder. The floor tool, its workpiece holder, and individual plates arranged thereon of a bipolar plate to be produced can thus be aligned properly in their processing position and clamped with the aid of the head tool and the floor tool for creating the welded bond between the two individual plates. This also promotes precise manufacturing of the bipolar plates.

If the device comprises at least two processing stations, at least two of the processing stations of the device can have different head tools for different clamping of the individual plates of the bipolar plates to be produced. The head tools of the processing stations are preferably arranged here in a stationary manner on the processing stations and above all in a stationary manner relative to the two laser scanners of the respective processing station.

In one preferred embodiment of the device, it has at least two, preferably a total of four floor tools, which can be moved from station to station of the device, for example, along the already above-mentioned conveying device, preferably on the rotary indexing table.

In this way, a floor tool can be assigned in each case to each work cycle of the device of each station of the device, thus, for example, the at least one processing station, the charging station, and the removal station. The device can have a number of head tools which corresponds to the number of the processing stations.

With the aid of the conveying device, the floor tools can then be moved from station to station in accordance with the manufacturing cycle, in order to transport the bipolar plate blanks or the finished bipolar plates from station to station in this case.

The device can have at least one actuator, in particular a servomotor, which is configured for positioning a workpiece holder of a floor tool relative to a head tool of a processing station. With the aid of such an actuator, the workpiece holder of a floor tool positioned at a processing station of the device can be moved from its starting position into its processing position.

In order to be able to refit the device comparatively easily for different bipolar plate patterns, it is advantageous if the device has at least one interchangeable holder for the at least one head tool and/or the at least one floor tool of the device and/or the at least one head tool and/or the at least one floor tool of the device are each designed as interchangeable tools.

To create the best possible, i.e., fluid-tight, preferably gas-tight, welded bond, it can furthermore be advantageous if the device has a protective gassing device. The protective gassing device can be configured to provide a workspace of the at least one processing station with a protective gas atmosphere; at least to do this when the welded bond between the two individual plates of a bipolar plate to be produced is to be created with the aid of the two laser scanners of a processing station.

In this case, the protective gassing device can be connected via a head tool and/or a floor tool of the device to the workspace of the processing station. The workspace can be limited by the head tool and/or the floor tool. A comparatively small, limited workspace is thus provided, which only requires a small amount of protective gas to create a protective gas atmosphere in the workspace. A corresponding protective gas outlet of the protective gassing device can be provided on the head tool and/or the floor tool in order to introduce protective gas into the workspace.

The device can furthermore have at least one handling device, which is configured for charging the device with individual plates and/or for removing finished bipolar plates.

In one embodiment of the handling device, it comprises at least one robot, which can preferably be designed as a swivel-arm robot. Furthermore, the handling device can comprise at least one gripper, for example, at least one suction gripper. The use of a suction gripper enables the particularly careful handling of individual plates or finished bipolar plates.

In one embodiment of the device, a charging station and a removal station of the device are each assigned a handling device.

### BRIEF DESCRIPTION OF THE DRAWINGS

The invention will be described in more detail hereinafter on the basis of an exemplary embodiment, but is not restricted to this exemplary embodiment. Further exemplary embodiments result by way of combination of the features of individual or several claims with one another and/or in combination of individual or several features of the exemplary embodiment.

In the figures:

FIG. 1 shows a perspective view of a device for producing bipolar plates, which has a charging station, two processing stations, and a removal station, wherein each of the two processing stations comprises two stationary laser scanners which are configured to create a fluid-tight, namely gas-tight, welded bond between two individual plates of a bipolar plate to be produced,

FIG. 2 shows a top view of the device shown in FIG. 1, wherein it can be seen that the total of four stations of the device are connected to one another by a conveying device, namely by a cycling device in the form of a rotary indexing table, and

FIG. 3 shows a perspective view of one of the two processing stations from FIGS. 1 and 2.

### DETAILED DESCRIPTION

All figures show at least parts of a device designated as a whole by 1 for producing bipolar plates 2, as can be used, for example, for fuel cells.

The device 1 has a total of two processing stations 3 and 4, which are each equipped with two stationary laser scanners 5. The laser scanners 5 are configured for the fluid-tight, namely gas-tight, welding of two individual plates 6 forming a bipolar plate 2.

In the first processing station 3 of the two processing stations 3 and 4 of the device 1, a first part of a fluid-tight, namely gas-tight welded bond connecting individual plates 6 of a bipolar plate 2 is created and in the second processing station 4 of the two processing stations 3 and 4, a second part of the welded bond connecting the individual plates 6 is created. The creation of the gas-tight welded bond between the two individual plates 6 is thus distributed onto the two processing stations 3 and 4 of the device.

The two laser scanners 5 of a processing station 3 and 4 form a double-field laser scanner. This is in that the two laser scanners 5 of a processing station 3 and 4 each have overlapping scanning fields. The scanning fields of the laser scanners 5 of the two processing stations 3 and 4 are sufficiently large here that they permit the processing even of different bipolar plate patterns without having to move the laser scanners 5 for this purpose. The laser scanners 5 can therefore remain fixed in position at their processing station 3 and 4 even with different bipolar plate patterns, which promotes the accuracy of the welded bond between the two individual plates 6 during the production of a bipolar plate 2.

The scanning fields of the laser scanners 5 are illustrated in the figures by the laser cones designated by 7. Each of the processing stations 3 and 4 has at least one optical sensor 8 in each case. This can be designed, for example, as a camera and/or as a so-called vision sensor of a vision system and can be integrated into one of the laser scanners 5.

The optical sensors 8 of the processing stations 3 and 4 are used, among other things, for so-called offsetting of the scanning fields of the laser scanners 5. A zero point can therefore be defined by the optical sensors 8 during the offsetting depending on the geometry, the arrangement, and the size of the bipolar plate 2 to be produced and its individual plates 6 before the actual laser welding, from which beam guiding of the laser scanners 5 for creating the welded bond is calculated or specified. This also promotes the high precision manufacturing of the bipolar plates 2. The optical sensors 8 can also be used for matching the scanning fields of the laser scanners 5.

The device 1 also comprises a conveying device 9, which is designed in the exemplary embodiment of the device 1 shown in the figures as a cycling device, specifically as a rotary indexing table. The two processing stations 3 and 4 of the device 1 and a charging station 10 and a removal station 11 of the device 1 are connected to one another for conveying by the conveying device 9.

The conveying device 9 in the form of the rotary indexing table of the device 1 has in each case a floor tool 12 for each of the stations 3, 4 and 10 and 11 of the device 1 and therefore has a total of four floor tools 12. The four floor tools 12 are used, on the one hand, as the transport means for the individual plates 6 or the finished bipolar plates 2 and, on the other hand, also as clamping plates for the individual plates 6 at the processing stations 3 and 4.

The total of 4 floor tools 12 each have for this purpose a workpiece holder 13, which can be moved from a starting position into a processing position and can be raised in the vertical direction, for at least one bipolar plate 2 or for two individual plates 6, which are still not connected, of a bipolar plate 2 to be produced.

Each of the two processing stations 3 and 4 additionally has a clamping device 14 for individual plates 6 of a bipolar plate 2 to be produced. The clamping device 14 of the processing stations 3 and 4 comprises a head tool 15 which is stationary, thus fixed in position, relative to the laser scanners 5 of the respective processing station 3 or 4. The head tool 15 and the two laser scanners 5 of each of the two processing stations 3 and 4 thus have unchangeable relative positions in relation to one another, which promotes the manufacturing accuracy during the creation of the welded bond between the two individual plates 6 of a bipolar plate 2 to be produced.

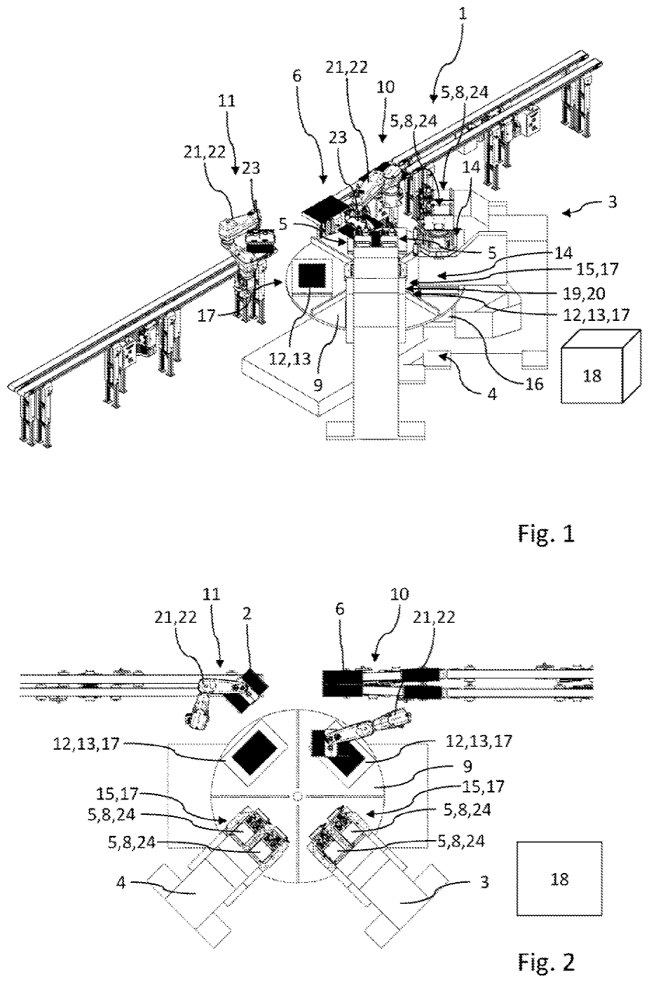

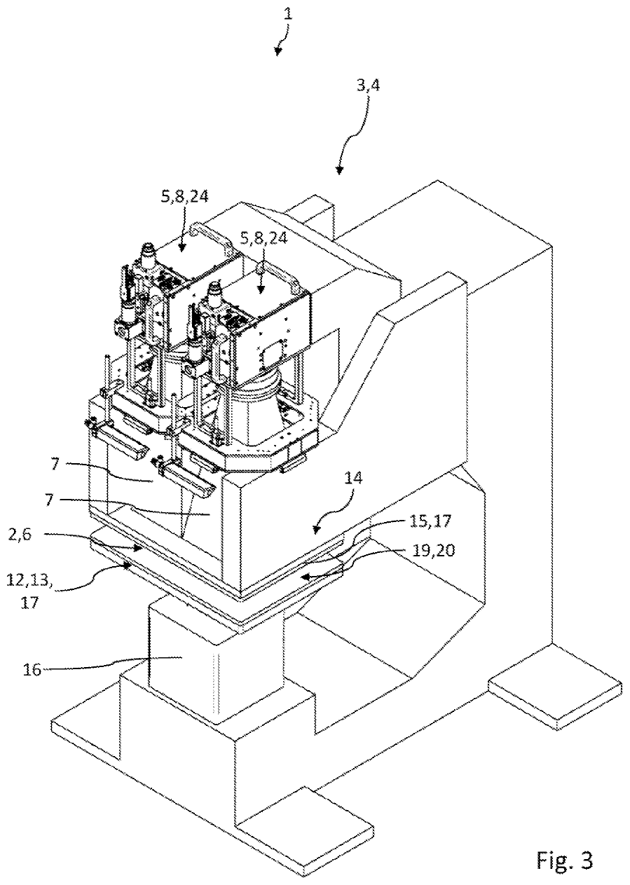

FIGS. 1 and 2 in particular illustrate that a floor tool 12 of the device 1 is at least temporarily assigned to each head tool 15. The head tools 15 are configured to properly align the movable workpiece holders 13 of the floor tools 12 and individual plates 6 arranged thereon of a bipolar plate 2 to be produced in their processing position for the proper creation of the welded bond between the two individual plates 6 and to clamp them with the aid of the head tool 15 and the floor tool 12. For the proper alignment of the workpiece holders 13, the head tools 15 and/or the workpiece holders 13 have corresponding centering means. Furthermore, the floor tools 12 are mounted floating, which promotes their proper alignment and centering on the head tools 15.

The floor tools 12 located at each of the processing stations 3 and 4 are at least temporarily part of the clamping device 14 of the respective processing station 3 and 4 here.

The device 1 has a total of four floor tools 12, which can be moved with the aid of the conveying device 9, designed as a rotary indexing table, cyclically from station to station of the device 1. The processing stations 3 and 4 of the device 1 each have an actuator 16, namely a servomotor, which is configured for positioning a workpiece holder 13 of a floor tool 12, which is arranged at the respective processing station 3 or 4, relative to the respective head tool 15 of the respective processing station 3 or 4.

The servomotor is configured to generate a vertical stroke, by which the workpiece holder 3 moves into a processing position or also clamping position on the head tool 15.

The device 1 has corresponding interchangeable holders 17 both for the head tools 15 and for the floor tools 12. Furthermore, both the head tools 15 and the floor tools 12 are designed as interchangeable tools, so that they can be exchanged comparatively easily for differently designed head tools 15 or floor tools 12 due to the interchangeable holder 17. The device 1 may thus be refitted easily in order to manufacture bipolar plates 2 according to other bipolar plate patterns.

The head tools 15 of the two processing stations 3 and 4 differ from one another insofar as they permit different ways of clamping the individual plates 6 of a bipolar plate 2 to be produced. This enables a different part of the welded bond to be created between the two individual plates 6 of the bipolar plate 2 to be produced in the first processing station 3 than in the second processing station 4. The second processing station 4 has a differently designed head tool 15 than the first processing station 3, using which the individual plates 6 of the bipolar plate 2 to be produced are clamped at different points. The different clamping then accordingly enables the creation of the remaining parts of the welded bond with the aid of the two laser scanners 5 of the second processing station 4.

The device 1 furthermore comprises a protective gassing device 18, which is configured to provide a workspace 19 of the respective processing station 3 or 4 of the device with a protective gas atmosphere. This can favorably influence the quality of the welded bond which is created with the aid of the laser scanners 5 of the respective processing station 3 and 4.

The protective gassing device 18 has a protective gas outlet 20, via which protective gas can be introduced into the respective workspace 19, at each processing station 3 and 4, for example, on the head tool 15 and/or on the floor tool 12. Because the workspace 19 is delimited by the respective head tool 15 and floor tool 12, it is comparatively small, which favorably reduces the requirement for protective gas for creating a protective gas atmosphere.

FIGS. 1 and 2 illustrate that the device 1 furthermore has two handling devices 21, which are configured for charging the device 1 with individual plates 6 or for removing finished bipolar plates 2. The two handling devices 21 are arranged adjacent to the rotary indexing table of the conveying device 9 and each comprise a swivel-arm robot 22, which has a suction gripper 23. The suction gripper 23 permits the particularly careful handling of the individual plates 6 and the finished bipolar plates 2.

The device 1 is configured, for example, by way of at least one control unit 24 configured for this purpose, to activate the laser scanners 5 of the two processing stations 3 and 4 so that the welded bond is symmetrically generated between two individual plates 6 and a symmetrical introduction of heat into the individual plates 6 takes place during the creation of the welded bond between two individual plates 6.

The invention relates to improvements in the technical area of producing bipolar plates 2, as are used, for example, for fuel cells. A device 1 is proposed for this purpose which has two fixed laser scanners 5 on at least one processing station 3, 4, which are configured for the preferably fluid-tight welding of individual plates 6 of a bipolar plate 2 to be produced.

### LIST OF REFERENCE NUMERALS

1 device
2 bipolar plate
3 first processing station
4 second processing station
laser scanner
6 individual plate
7 laser cone
8 optical sensor
9 conveying device
charging station
11 removal station
12 floor tool
13 workpiece receptacle
14 clamping device
head tool
16 actuator
17 interchangeable holder
18 protective gassing device
19 workspace
protective gas outlet
21 handling device
22 swivel-arm robot
23 suction gripper
24 control unit

1. A device (1) for producing bipolar plates (2), the device comprising:
at least one processing station (3, 4), which comprises at least two stationary laser scanners (5), which are configured to create at least one of a fluid-tight or gas-tight welded bond between two individual plates (6) forming one of the bipolar plates (2).

2. The device (1) as claimed in claim 1, further comprising at least one control unit (24) configured to activate the two laser scanners (5) of the at least one processing station (3, 4) so that the welded bond between the two individual plates (3) is at least one of created symmetrically or provides for a symmetrical introduction of heat into the individual plates (6) during creation of the welded bond between two individual plates (6).

3. The device (1) as claimed in claim 1, wherein the at least one processing station includes two processing stations (3, 4), which each comprise two of the stationary laser scanners (5), which are configured to create the at least one of the fluid-tight or gas-tight welded bond between the two individual plates (6) forming the bipolar plate (2).

4. The device (1) as claimed in claim 3, wherein a first part of the welded bond connecting the two individual plates (6) of the bipolar plate (2) is adapted to be created in a first processing station (3) of the two processing stations (3, 4) and a second part of the welded bond connecting the individual plates (6) is adapted to be created in a second processing station (4).

5. The device (1) as claimed in claim 1, wherein the two laser scanners of the at least one processing station (3, 4) form a double-field laser scanner.

6. The device (1) as claimed in claim 1, wherein the at least one processing station (3, 4) has at least one optical sensor (8) that is adapted to at least one of a) check a position of the welded bond created using the two laser scanners or b) control the two laser scanners, c) match scanning fields of the two laser scanners, or d) offset scanning fields of the two laser scanners.

7. The device (1) as claimed in claim 1, further comprising a conveying device (9) via which at least one of a) the at least one processing station (3, 4), b) a charging station (10), or c) a removing station (11) are connected to one another for conveying.

8. The device (1) as claimed in claim 1, further comprising a floor tool (12), which comprises a workpiece receptacle (13) for at least one of the bipolar plates (2) that is movable from a starting position into a processing position, for each station (3, 4, 10, 11) of the device (1).

9. The device (1) as claimed in claim 1, wherein each of the at least one processing station (3, 4) has a clamping device (14) for individual ones of the plates (6) of the bipolar plate (2) to be produced, the clamping device having a head tool (15) that is stationary relative to the laser scanners (5) of the processing station (3, 4).

10. The device (1) as claimed in claim 9, further comprising a movable floor tool (12), which has a workpiece receptacle (13), assigned at least temporarily to the head tool (15), the floor tool (12) is centerable using the head tool (15), in order to properly align the workpiece receptacle (13) and individual ones of the plates (6) arranged thereon of the bipolar plate (2) to be produced in their processing position and to clamp the plates using the head tool (15) and the floor tool (12).

11. The device (1) as claimed in claim 10, wherein there are at least two of the floor tools (12), which are moveable from station to station of the device (1).

12. The device (1) as claimed in claim 1, further comprising at least one actuator (16) configured for positioning a workpiece receptacle (13) of a floor tool (12) relative to a head tool (15) of the at least one processing station (3, 4).

13. The device (1) as claimed in claim 12, further comprising an interchangeable holder (17) for at least one of the at least one head tool (15) or for at least one floor tool (12).

14. The device (1) as claimed in claim 1, further comprising a protective gassing device (18), which is configured to provide a workspace (19) of the at least one processing station (3, 4) with a protective gas atmosphere.

15. The device (1) as claimed in claim 1, further comprising at least one handling device (21), which is configured for at least one of charging the device (1) with the individual plates (6) or for removing the bipolar plates (2).

16. The device (1) as claimed in claim 15, wherein the at least one handling device (21) comprises at least one of a robot, at least one gripper, or a suction gripper (23).

17. The device (1) as claimed in claim 1, wherein the laser scanners (5) of the at least one processing station (3, 4) have overlapping scanning fields.

18. The device (1) as claimed in claim 12, wherein at least one of the at least one head tool (15) or the at least one floor tool (12) are designed as an interchangeable tool.
